(19) United States
(12) Patent Application Publication
(10) Pub. No.: US 2016/0360061 A1
(43) Pub. Date: Dec. 8, 2016

(54) INFORMATION PROCESSING SYSTEM, INFORMATION PROCESSING APPARATUS, AND APPLICATION METHOD

(71) Applicant: Toshio AKIYAMA, Tokyo (JP)

(72) Inventor: Toshio AKIYAMA, Tokyo (JP)

(73) Assignee: Ricoh Company, Ltd., Tokyo (JP)

(21) Appl. No.: 15/137,061

(22) Filed: Apr. 25, 2016

(30) Foreign Application Priority Data
Jun. 4, 2015 (JP) 2015-114260

(51) Int. Cl. H04N 1/32; G06F 3/12; H04N 1/00

(52) U.S. Cl. CPC H04N 1/32112; H04N 1/00344; G06F 3/1205; G06F 3/1238; G06F 3/1225; H04N 2201/0094

(57) ABSTRACT

Provided are a setting-information receiving unit that receives, from a user terminal, the setting information that includes the function setting information that indicates the printing setting of a printer driver for a device and the user identification information on the user who uses the user terminal and that stores it in a setting-information storage unit; a request-information receiving unit that receives, from the shared terminal, the request information that includes the user identification information; an application-information generating unit that acquires, from the setting-information storage unit, the function setting information, included in the setting information that includes the user identification information, included in the request information and that generates an installation package for applying the printing setting, indicated by the function setting information, to the printing setting of the printer driver of a shared terminal for the device; and a delivering unit that delivers the installation package to the shared terminal.

### CROSS-REFERENCE TO RELATED APPLICATIONS

The present application claims priority under 35 U.S.C. §119 to Japanese Patent Application No. 2015-114260 filed in Japan on Jun. 4, 2015. The contents of which are incorporated herein by reference in their entirety.

### BACKGROUND OF THE INVENTION

1. Field of the Invention

The present invention relates to an information processing system, an information processing apparatus, and an application method.

2. Description of the Related Art

There is a conventionally-known technology for installing a setting file, indicating a predetermined printing setting, in an installation package of a printer driver so that it is ensured that the predetermined printing setting is applied to the printer driver (see, for example, Japanese Patent Application Laid-open No. 2006-260114).

In view of the conventional technology, there is a need to provide an information processing system, an information processing apparatus, and an application method, which make it possible to apply the function setting appropriately for the use mode.

### SUMMARY OF THE INVENTION

It is an object of the present invention to at least partially solve the problems in the conventional technology.

According to exemplary embodiments of the present invention, there is provided an information processing system comprising: a first information processing apparatus; a second information processing apparatus; and a delivery system, wherein the first information processing apparatus includes a processor, in communication with a memory, executes steps of: acquiring function setting information that indicates a function setting of a first device driver applied to the first information processing apparatus to control a first device that is used with the first information processing apparatus and user identification information for identifying a user who uses the first information processing apparatus; and transmitting setting information including the function setting information and the user identification information to the delivery system, the delivery system includes a processor, in communication with a memory, executes steps of: receiving the setting information from the first information processing apparatus and stores the setting information; receiving request information including the user identification information on the user from the second information processing apparatus; acquiring function setting information included in setting information that includes the user identification information included in the request information and generating application information for applying a function setting indicated by the function setting information; and delivering the application information to the second information processing apparatus, and the second information processing apparatus includes a processor, in communication with a memory, executes steps of: transmitting the request information to the delivery system; receiving the application information from the delivery system; and applying the application information to apply a function setting indicated by the function setting information to a function setting of a second device driver applied to the second information processing apparatus to control a second device that is used with the second information processing apparatus with regard to the second device.

Exemplary embodiments of the present invention also provide an information processing apparatus comprising a processor, in communication with a memory, executes steps of: receiving from a first information processing apparatus setting information including function setting information that indicates a function setting of a first device driver applied to the first information processing apparatus to control a first device that is used with the first information processing apparatus with regard to the first device and user identification information for identifying a user who uses the first information processing apparatus; receiving request information including the user identification information on the user from a second information processing apparatus; acquiring function setting information included in setting information that includes the user identification information included in the request information and generating application information for applying a function setting indicated by the function setting information to a function setting of a second device driver applied to the second information processing apparatus to control a second device that is used with the second information processing apparatus; and delivering the application information to the second information processing apparatus.

Exemplary embodiments of the present invention also provide an application method that is implemented by an information processing system that includes a first information processing apparatus, a second information processing apparatus, and a delivery system, the application method comprising steps of: acquiring function setting information that indicates a function setting of a first device driver applied to the first information processing apparatus to control a first device that is used with the first information processing apparatus with regard to the first device and user identification information for identifying a user who uses the first information processing apparatus; and transmitting setting information including the function setting information and the user identification information to the delivery system, receiving the setting information from the first information processing apparatus; receiving request information including the user identification information on the user from the second information processing apparatus; acquiring function setting information included in setting information that includes the user identification information included in the request information and generating application information for applying a function setting indicated by the function setting information; and delivering the application information to the second information processing apparatus, and transmitting the request information to the delivery system; receiving the application information from the delivery system; and applying the application information to apply a function setting indicated by the function setting information to a function setting of a second device driver applied to the second information processing apparatus to control a second device that is used with the second information processing apparatus with regard to the second device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram that illustrates an example of the configuration of an information processing system according to a first embodiment of the present invention;

FIG. 2 is a block diagram that illustrates an example of the hardware component of a user terminal according to the first embodiment;

FIG. 3 is a block diagram that illustrates an example of the hardware component of a delivery server according to the first embodiment;

FIG. 4 is a block diagram that illustrates an example of the hardware component of a correspondence management server according to the first embodiment;

FIG. 5 is a block diagram that illustrates an example of the hardware component of a driver management server according to the first embodiment;

FIG. 6 is a block diagram that illustrates an example of the hardware component of a shared terminal according to the first embodiment;

FIG. 7 is a block diagram that illustrates an example of the functional configuration of an information processing system according to the first embodiment;

FIG. 8 is a diagram that illustrates an example of the print setting screen of a printer driver according to the first embodiment;

FIG. 9 is a table that illustrates an example of the setting information that is stored in a setting-information storage unit according to the first embodiment;

FIG. 10 is a table that illustrates an example of the correspondence information that is stored in a correspondence-information storage unit according to the first embodiment;

FIG. 11 is a sequence diagram that illustrates an example of an operation to store the setting information, executed by the information processing system according to the first embodiment;

FIG. 12 is a sequence diagram that illustrates an example of an operation to deliver the installation package, executed by the information processing system according to the first embodiment;

FIG. 13 is a block diagram that illustrates an example of the configuration of an information processing system according to a second embodiment of the present invention;

FIG. 14 is a block diagram that illustrates an example of the functional configuration of the information processing system according to the second embodiment;

FIG. 15 is a sequence diagram that illustrates an example of an operation to store the setting information, performed by the information processing system according to the second embodiment; and

FIG. 16 is a sequence diagram that illustrates an example of an operation to deliver an installation package, performed by the information processing system according to the second embodiment.

### DETAILED DESCRIPTION OF THE PREFERRED EMBODIMENTS

With reference to the attached drawings, a detailed explanation is given below of embodiments of an information processing system, an information processing apparatus, and an application method according to the present invention.

### First Embodiment

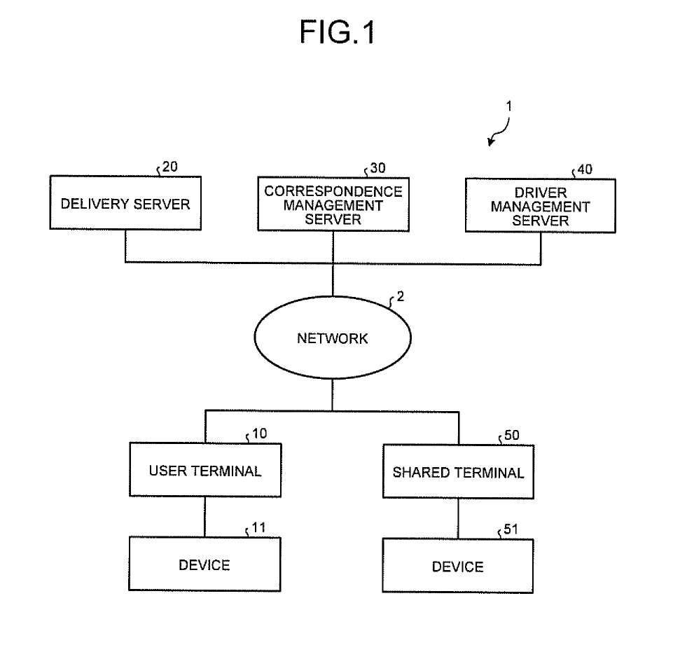

FIG. 1 is a block diagram that illustrates an example of the configuration of an information processing system 1 according to a first embodiment. As illustrated in FIG. 1, the information processing system 1 includes a user terminal 10, a device 11, a delivery server 20, a correspondence management server 30, a driver management server 40, a shared terminal 50, and a device 51.

Furthermore, the user terminal 10 is an example of a first information processing apparatus, the device 11 is an example of a first device, the delivery server 20, the correspondence management server 30, and the driver management server 40 are an example of a delivery system, the delivery server 20 is an example of an information processing apparatus, the shared terminal 50 is an example of a second information processing apparatus, and the device 51 is an example of a second device.

The user terminal 10, the delivery server 20, the correspondence management server 30, the driver management server 40, and the shared terminal 50 are connected via a network 2. The network 2 includes, for example, a local area network (LAN) or the Internet.

Furthermore, the user terminal 10 is connected to the device 11, and the shared terminal 50 is connected to the device 51. The connection topology between the user terminal 10 and the device 11 may be a network connection using the network 2 or a local connection using a communication cable, such as a universal serial bus (USB) cable. Also, the connection topology between the shared terminal 50 and the device 51 may be a network connection using the network 2 or a local connection using a communication cable.

The device 11 is the device that is used by the user terminal 10, and the device 51 is the device that is used by the shared terminal 50. The devices 11 and 51 are equivalent to, for example, image forming apparatuses, such as printing devices, copiers, multifunction peripherals, scanner devices, or facsimile machines, or various types of electronic devices, such as projectors, cameras, air conditioners, refrigerators, fluorescent lights, automatic dispensers, or hand-held terminals. Multifunction peripherals (MFPs) have at least two functions out of a copier function, printer function, scanner function, and facsimile function. Furthermore, according to the first embodiment, an explanation is given of a case where, for example, the devices 11 and 51 are printing devices; however, this is not a limitation.

The user terminal 10 is a terminal device that is used by a user, and the user terminal 10 includes, for example, a personal computer (PC) or a smart device. According to the first embodiment, an explanation is given of a case where, for example, the user terminal 10 is a terminal device dedicated for the user; however, this is not a limitation. Moreover, the user terminal 10 has installed (an example of application) a printer driver (an example of a first device driver) for controlling the device 11.

The shared terminal 50 is a terminal device that is used by a large number of users, including the user of the user terminal 10, and it includes, for example, a personal computer (PC), a server, or a smart device.

Furthermore, the user terminal 10 and the device 11 may be located in an area (space) different from the shared terminal 50 and the device 51 or may be located in the same area (space) as them. In the first embodiment, an explanation is given of a case where, for example, the user terminal 10 and the device 11 are located in a main office and the shared terminal 50 and the device 51 are located in a satellite office; however, this is not a limitation. For example, the shared terminal 50 and the device 51 may be located in an area (space) for providing a public printing service.

The delivery server 20 is a server device that delivers, to the shared terminal 50, an installation package (specifically, an installation package program) to apply the printing setting (an example of the function setting) of the printer driver, installed in the user terminal 10, with regard to the device 11 to the terminals other than the user terminal 10, and it includes, for example, a computer.

The correspondence management server 30 is a server device that manages the correspondence information, in which the device identification information for identifying the device is related to the device-driver identification information for identifying the printer driver to control the device, and it includes, for example, a computer.

The driver management server 40 is a server device that manages a printer driver (specifically, a printer driver program), and it includes, for example, a computer.

Furthermore, the delivery server 20, the correspondence management server 30, and the driver management server 40 may be provided together in a single device without setting them as separate devices.

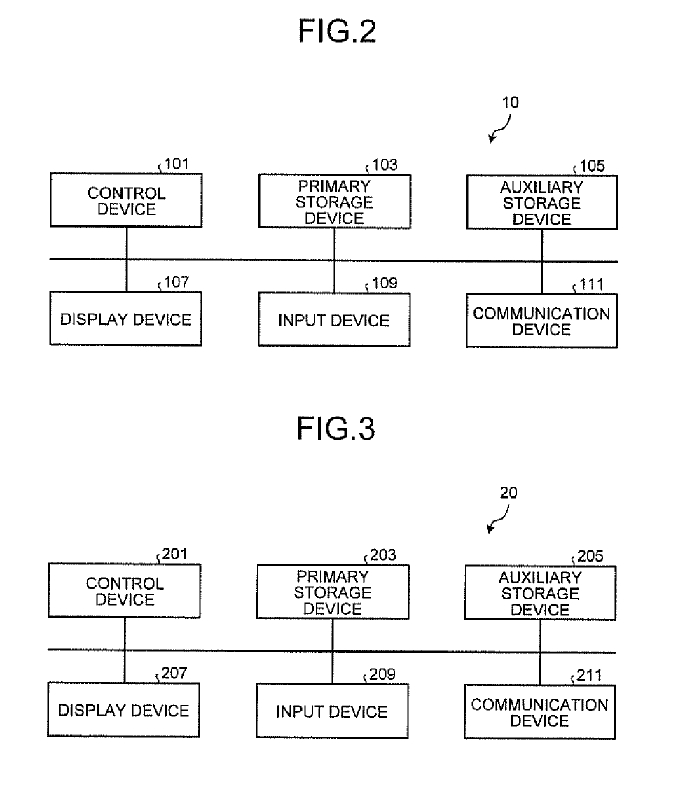

FIG. 2 is a block diagram that illustrates an example of the hardware component of the user terminal 10 according to the first embodiment. As illustrated in FIG. 2, the user terminal 10 includes a control device 101, such as a central processing unit (CPU) or a graphics processing unit (GPU); a primary storage device 103, such as a read only memory (ROM) or a random access memory (RAM); an auxiliary storage device 105, such as a hard disk drive (HDD) or a solid state drive (SSD); a display device 107, such as a display; an input device 109, such as a mouse, a keyboard, or a touch panel; and a communication device 111, such as a communication interface, and it has the hardware component that uses a typical computer. Furthermore, the auxiliary storage device 105, the display device 107, the input device 109, and the communication device 111 may be built-in or externally connected.

FIG. 3 is a block diagram that illustrates an example of the hardware component of the delivery server 20 according to the first embodiment. As illustrated in FIG. 3, the delivery server 20 includes a control device 201, such as a CPU or a GPU; a primary storage device 203, such as a ROM or a RAM; an auxiliary storage device 205, such as an HDD or an SSD; a display device 207, such as a display; an input device 209, such as a mouse, a keyboard, or a touch panel; and a communication device 211, such as a communication interface, and it has the hardware component that uses a typical computer. Furthermore, the auxiliary storage device 205, the display device 207, the input device 209, and the communication device 211 may be built-in or externally connected.

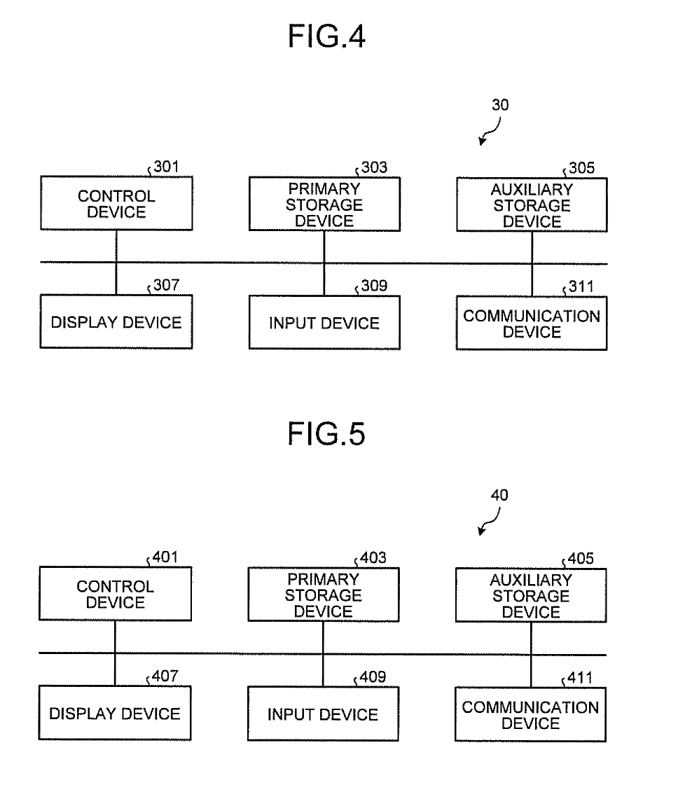

FIG. 4 is a block diagram that illustrates an example of the hardware component of the correspondence management server 30 according to the first embodiment. As illustrated in FIG. 4, the correspondence management server 30 includes a control device 301, such as a CPU or a GPU; a primary storage device 303, such as a ROM or a RAM; an auxiliary storage device 305, such as an HDD or an SSD; a display device 307, such as a display; an input device 309, such as a mouse, a keyboard, or a touch panel; and a communication device 311, such as a communication interface, and it has the hardware component that uses a typical computer. Furthermore, the auxiliary storage device 305, the display device 307, the input device 309, and the communication device 311 may be built-in or externally connected.

FIG. 5 is a block diagram that illustrates an example of the hardware component of the driver management server 40 according to the first embodiment. As illustrated in FIG. 5, the driver management server 40 includes a control device 401, such as a CPU or a GPU; a primary storage device 403, such as a ROM or a RAM; an auxiliary storage device 405, such as an HDD or an SSD; a display device 407, such as a display; an input device 409, such as a mouse, a keyboard, or a touch panel; and a communication device 411, such as a communication interface, and it has the hardware component that uses a typical computer. Furthermore, the auxiliary storage device 405, the display device 407, the input device 409, and the communication device 411 may be built-in or externally connected.

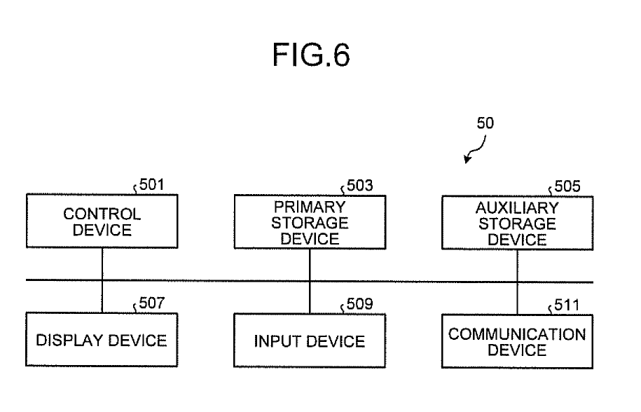

FIG. 6 is a block diagram that illustrates an example of the hardware component of the shared terminal 50 according to the first embodiment. As illustrated in FIG. 6, the shared terminal 50 includes a control device 501, such as a CPU or a GPU; a primary storage device 503, such as a ROM or a RAM; an auxiliary storage device 505, such as an HDD or an SSD; a display device 507, such as a display; an input device 509, such as a mouse, a keyboard, or a touch panel; and a communication device 511, such as a communication interface, and it has the hardware component that uses a typical computer. Furthermore, the auxiliary storage device 505, the display device 507, the input device 509, and the communication device 511 may be built-in or externally connected.

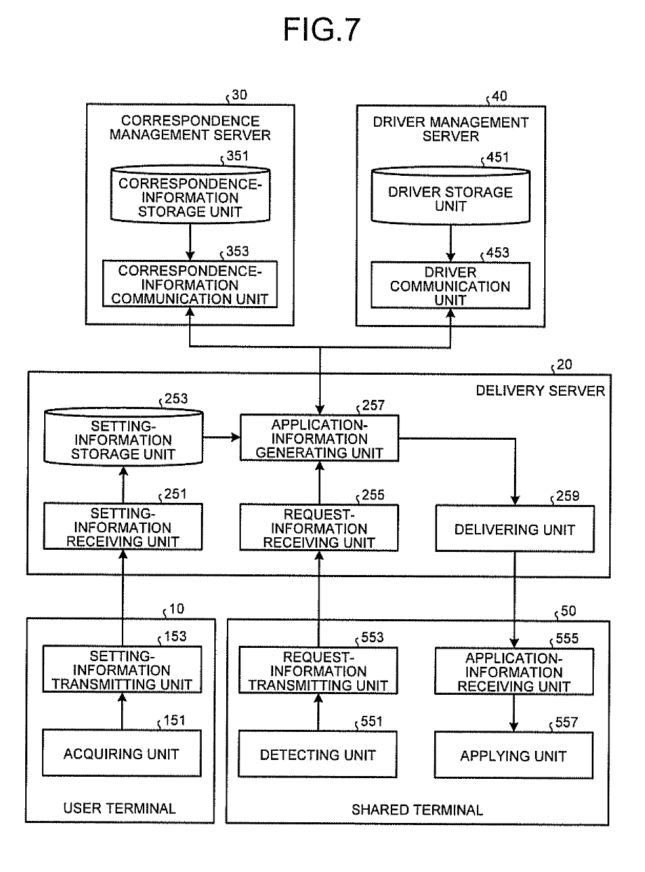

FIG. 7 is a block diagram that illustrates an example of the functional configuration of the information processing system 1 according to the first embodiment. As illustrated in FIG. 7, the user terminal 10 includes an acquiring unit 151 and a setting-information transmitting unit 153. The acquiring unit 151 and the setting-information transmitting unit 153 are the functions that are implemented by a setting management program (setting management software), installed in the user terminal 10, and they may be implemented by, for example, the control device 101, the primary storage device 103, and the communication device 111.

Furthermore, as illustrated in FIG. 7, the delivery server 20 includes a setting-information receiving unit 251, a setting-information storage unit 253, a request-information receiving unit 255, an application-information generating unit 257, and a delivering unit 259. The setting-information receiving unit 251, the request-information receiving unit 255, the application-information generating unit 257, and the delivering unit 259 are the functions that are implemented by an installation-package generation program (installation-package generation software), installed in the delivery server 20, and they may be implemented by, for example, the control device 201, the primary storage device 203, and the communication device 211. The setting-information storage unit 253 may be implemented by, for example, the auxiliary storage device 205.

Furthermore, as illustrated in FIG. 7, the correspondence management server 30 includes a correspondence-information storage unit 351 and a correspondence-information communication unit 353. The correspondence-information storage unit 351 may be implemented by, for example, the auxiliary storage device 305, and the correspondence-information communication unit 353 may be implemented by, for example, the control device 301, the primary storage device 303, and the communication device 311.

Furthermore, as illustrated in FIG. 7, the driver management server 40 includes a driver storage unit 451 and a driver communication unit 453. The driver storage unit 451 may be implemented by, for example, the auxiliary storage device 405, and the driver communication unit 453 may be implemented by, for example, the control device 401, the primary storage device 403, and the communication device 411.

Furthermore, as illustrated in FIG. 7, the shared terminal 50 includes a detecting unit 551, a request-information transmitting unit 553, an application-information receiving unit 555, and an applying unit 557. The detecting unit 551, the request-information transmitting unit 553, and the application-information receiving unit 555 are the functions that are implemented by an installation package request/execution program (installation package request/execution software) that is installed in the shared terminal 50, and they may be implemented by, for example, the control device 501, the primary storage device 503, and the communication device 511. The applying unit 557 is the function that is implemented by installing an installation package (specifically, an installer that is included in the installation package) in the shared terminal 50, and it may be implemented by, for example, the control device 501 and the primary storage device 503.

The acquiring unit 151 acquires the function setting information that indicates the printing setting of the printer driver, installed in the user terminal 10, with regard to the device 11 and the user identification information for identifying the user who uses the user terminal 10.

Here, the acquiring unit 151 may extract the printing setting with regard to the device 11 from the printer driver of the user terminal 10 to acquire the function setting information, or it may acquire the function setting information that is previously generated by the printer driver of the user terminal 10.

In the former case, for example, if the printer icon, indicating the device 11, is selected by using the input device 109 among the printer icons, managed in the printer driver of the user terminal 10, on the management screen of the setting management program, installed in the user terminal 10, the acquiring unit 151 extracts, from the printer icon, the printing setting with regard to the device 11, managed in the printer icon, so as to acquire the function setting information. In the case of this technique, there is an advantage such that the function setting information may be automatically extracted; however, with some types of printer drivers, all the printing settings may not be extracted.

In the latter case, for example, the user uses the input device 109 to previously perform an operation to store the function setting information that indicates the printing setting with regard to the device 11, managed in the printer icon that indicates the device 11, on the property screen of the printer driver of the user terminal 10. Then, if the stored function setting information is selected by using the input device 109 on the management screen of the setting management program, installed in the user terminal 10, the acquiring unit 151 acquires the function setting information. In the case of this technique, there is a need to manually store the printing setting in advance; however, there is an advantage such that, as the printer driver stores the printing settings, all the printing settings may be stored. However, the printer driver needs to have the function to store the printing settings.

Furthermore, in either the former case or the latter case, the number of printer icons that indicate the device 11 is not always one. For example, if multiple printing settings are registered for the device 11 in the printer driver of the user terminal 10, the number of existing printer icons, indicating the device 11, corresponds to the number of printing settings. In this case, there may be one or more printer icons that are the targets for extraction and storage of the printing settings.

Extraction and storage of the printing settings may be achieved by using DEVMODE, which is a Windows (registered trademark) standard I/F, PrintTicket or PrintCapabilities, which is a Windows expansion I/F, printui.dll, which is a tool that is provided by Microsoft (registered trademark), and the function that is installed in the printer driver. Furthermore, not only the printing settings but also the identification information on the printer driver, such as the model name of the printer driver, may be extracted or stored.

The printing setting includes, for example, the document size setting, sheet size setting, sheet type setting, combining setting, printed-side (one-sided/two-sided) setting, post-processing (bookbinding, stapling, punching, or the like) setting, color (colored, monochrome, or the like) setting, copy number setting, or authentication setting; however, these are not limitations. Furthermore, in order to restrict the printing functions, the settings may be made such that each of the settings is locked or restricted. For example, the color setting may be locked for monochrome so as to restrict (prohibit) color printing, the sheet size setting may be restricted to B5 or A4 so as to restrict (prohibit) A3 printing, or the authentication setting may be locked for providing authentication so as to make the authentication indispensable.

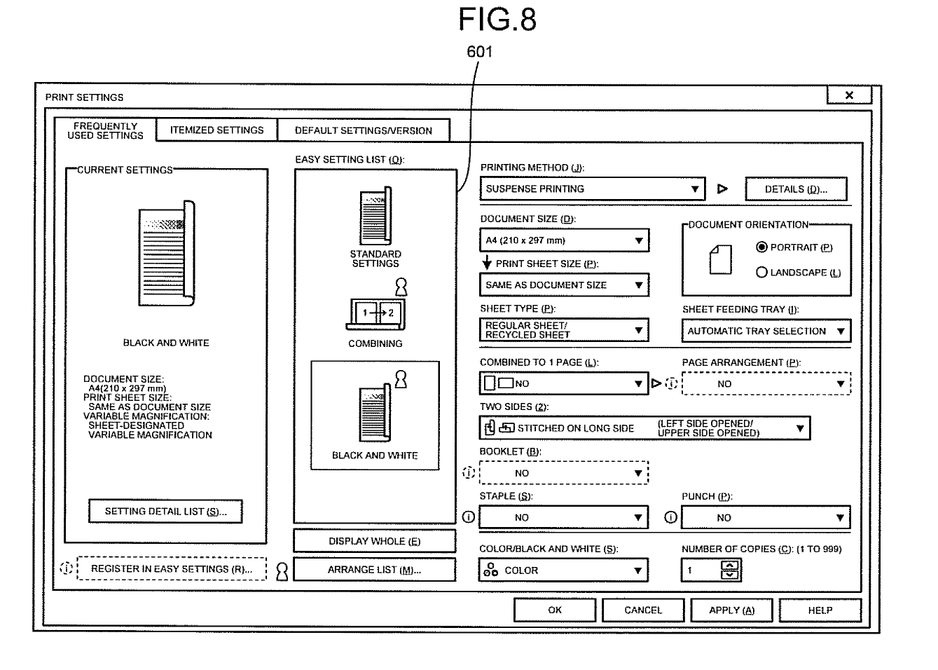

Furthermore, the printing settings may include not only the printing settings that are set at present, but also the default settings, pre-set settings, or the like. The default settings are the printing settings that are set by default for the device 11 when the printer driver is installed in the user terminal 10. The pre-set settings are the printing settings of the pattern with a high usage frequency, previously registered in the printer driver. For example, the pre-set settings include “standard settings”, “combining”, or “black and white” in an easy setting list 601 on the print setting screen of the printer driver, illustrated in FIG. 8.

The user identification information on the user who uses the user terminal 10 includes, for example, the login ID of the user, which is input from the input device 109 when the user logs in the user terminal 10. An explanation is given below of a case where, for example, the login ID of the user who uses the user terminal 10 is “user0001”; however, this is not a limitation. Furthermore, if there is a need to input the domain ID during login, the user identification information may include the domain ID.

The setting-information transmitting unit 153 transmits, to the delivery server 20, the setting information that includes the function setting information and the user identification information, acquired by the acquiring unit 151.

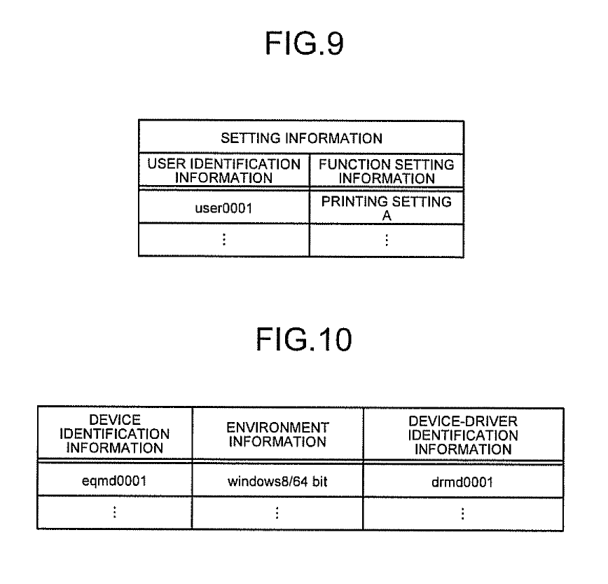

The setting-information receiving unit 251 receives the setting information from the user terminal 10 and stores it in the setting-information storage unit 253. FIG. 9 is a table that illustrates an example of the setting information (the user identification information and the function setting information) that is stored in the setting-information storage unit 253 according to the first embodiment, and it stores the setting information that includes the setting information on the user who uses the user terminal 10.

The detecting unit 551 detects that the user has the authority to use the shared terminal 50 based on an input of the user identification information on the user. As described above, according to the first embodiment, as the user identification information is the login ID of the user, the detecting unit 551 detects login of the user by using the login ID, thereby detecting that the user has authority to use the shared terminal 50.

For example, when the user, who uses the user terminal 10, inputs the login ID “user0001” and the password to the shared terminal 50 from the input device 509 and logs in the shared terminal 50, the detecting unit 551 detects that the user with the login ID “user0001” logs in. Furthermore, if there is a need to input the domain ID during login, the domain ID is also input to the shared terminal 50.

The request-information transmitting unit 553 transmits, to the delivery server 20, the request information that includes the user identification information on the user. According to the first embodiment, the request-information transmitting unit 553 transmits the request information to the delivery server 20 based on detection of the use authority (login) by the detecting unit 551.

Specifically, when the detecting unit 551 detects login, the request-information transmitting unit 553 transmits, to the delivery server 20, the request information that includes the user identification information on the user, of which the login has been detected, the device identification information for identifying the device 51, and the environment information that indicates the environment of the shared terminal 50.

An explanation is given of a case where, for example, the user identification information is the login ID “user0001” of the user who uses the user terminal 10 as described above; however, this is not a limitation.

The device identification information includes, for example, the model name of the device. For example, the request-information transmitting unit 553 conducts a Simple Network Management Protocol (SNMP) communication with the device 51, thereby acquiring the device identification information on the device 51. An explanation is given below of a case where, for example, the device identification information on the device 51 is “eqmd0001”; however, this is not a limitation.

The environment information includes, for example, the type of operating system (OS), installed in the shared terminal 50, or the number of bits. The request-information transmitting unit 553 acquires the environment information from the OS that is installed in the shared terminal 50. An explanation is given below of a case where, for example, the environment information on the shared terminal 50 is “windows 8/32 bit”; however, this is not a limitation.

The request-information receiving unit 255 receives the request information from the shared terminal 50.

The application-information generating unit 257 acquires, from the setting-information storage unit 253, the function setting information included in the setting information, which includes the user identification information, included in the request information that is received by the request-information receiving unit 255, and it generates an installation package (an example of the application information) for applying the function setting, indicated by the function setting information.

Specifically, on the basis of the correspondence information, in which the device identification information on the device is related to the device-driver identification information for identifying the printer driver to control the device, the application-information generating unit 257 acquires the printer driver (an example of a second device driver) that is indicated by the device-driver identification information that corresponds to the device identification information on the device 51, installs the acquired printer driver, and generates the installation package for applying the function setting, indicated by the acquired function setting information, to the installed printer driver.

For example, the application-information generating unit 257 transmits the device identification information on the device 51 and the environment information on the shared terminal 50, included in the request information that is received by the request-information receiving unit 255, to the correspondence management server 30, thereby requesting the device-driver identification information on the printer driver to control the device 51 in the environment of the shared terminal 50.

The correspondence-information storage unit 351 stores the correspondence information that relates the device identification information on a device, the environment information on a terminal, and the device-driver identification information for identifying the printer driver to control the device in the environment that is indicated by the environment information. FIG. 10 is a table that illustrates an example of the correspondence information that is stored in the correspondence-information storage unit 351 according to the first embodiment.

When the correspondence-information communication unit 353 receives the device identification information on the device 51 and the environment information on the shared terminal 50 from the delivery server 20, it acquires, from the correspondence-information storage unit 351, the device-driver identification information that is related to the device identification information and the environment information and replies to the delivery server 20. For example, if the device identification information on the device 51 is “eqmd0001”, the environment information on the shared terminal 50 is “windows 8/32 bit”, and the correspondence information is the information that is illustrated in FIG. 10, the correspondence-information communication unit 353 acquires the device-driver identification information “drmd0001” from the correspondence-information storage unit 351 and replies to the delivery server 20.

When the application-information generating unit 257 acquires the device-driver identification information from the correspondence management server 30, it transmits the device-driver identification information to the driver management server 40, thereby requesting the printer driver to control the device 51 in the environment of the shared terminal 50.

The driver storage unit 451 stores the printer driver and the device-driver identification information on the printer driver in a related manner.

When the driver communication unit 453 receives the device-driver identification information from the delivery server 20, the driver communication unit 453 acquires, from the driver storage unit 451, the printer driver that is related to the device-driver identification information and replies the printer driver to the delivery server 20. For example, if the device-driver identification information is “drmd0001”, the driver communication unit 453 acquires the printer driver that is related to the device-driver identification information “drmd0001” from the driver storage unit 451 and replies the printer driver to the delivery server 20.

When the application-information generating unit 257 acquires the printer driver to control the device 51 in the environment of the shared terminal 50 from the driver management server 40, it acquires, from the setting-information storage unit 253, the function setting information that is included in the setting information that includes the user identification information, included in the request information that is received by the request-information receiving unit 255. For example, if the user identification information, included in the request information, is “user0001” and the setting information is the information that is illustrated in FIG. 9, the application-information generating unit 257 acquires the function setting information “printing setting A” from the setting-information storage unit 253.

Then, the application-information generating unit 257 installs the acquired printer driver in the shared terminal 50 and generates the installation package for applying the function setting, indicated by the acquired function setting information, to the installed printer driver. Here, the installation package may be generated by using a well-known technology.

The delivering unit 259 delivers the installation package, generated by the application-information generating unit 257, to the shared terminal 50.

The application-information receiving unit 555 receives the installation package from the delivery server 20.

On the basis of the installation package that is received by the application-information receiving unit 555, the applying unit 557 applies the printing setting, indicated by the function setting information which is used to generate the installation package, to the printing setting of the printer driver for the device 51, installed in the shared terminal 50 to control the device 51.

Specifically, on the basis of the installation package that is received by the application-information receiving unit 555, the applying unit 557 installs the printer driver in the shared terminal 50 to control the device 51 and applies the printing setting, indicated by the function setting information, which is used to generate the installation package, to the printing setting of the printer driver for the device 51.

For example, when the application-information receiving unit 555 executes the received installation package so that the installer of the installation package is installed in the shared terminal 50, the applying unit 557 installs the printer driver for controlling the device 51, included in the installation package, in the shared terminal 50 and generates a port for the printer driver. Then, the applying unit 557 notifies the installed printer driver of the printing setting, indicated by the function setting information, which is used to generate the installation package, and gives a command to register the printing setting. Thus, the printer driver, installed in the shared terminal 50, applies the notified printing setting to the printing setting for the device 51 and registers the printer icon that indicates the device 51 and that manages the printing setting for the device 51.

Thus, when the user uses the device 51 with the shared terminal 50, the user may use the printing setting in the same manner as in the case where the device 11 is used with the user terminal 10 without manually changing the printing setting.

Furthermore, when the detecting unit 551 detects that the user logs off the shared terminal 50, the applying unit 557 uninstalls the printer driver, which is installed in the shared terminal 50.

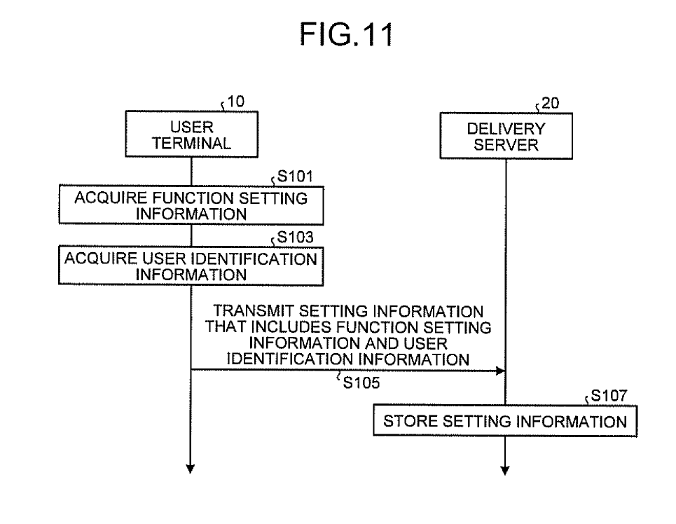

FIG. 11 is a sequence diagram that illustrates an example of an operation to store the setting information, executed by the information processing system 1 according to the first embodiment.

First, the acquiring unit 151 acquires the function setting information that indicates the printing setting of the printer driver for the device 11, installed in the user terminal 10 (Step S101).

Next, the acquiring unit 151 acquires the user identification information on the user who uses the user terminal 10 (Step S103).

Then, the setting-information transmitting unit 153 transmits, to the delivery server 20, the setting information that includes the function setting information and the user identification information, acquired by the acquiring unit 151, and the setting-information receiving unit 251 receives the setting information from the user terminal 10 (Step S105).

Next, the setting-information receiving unit 251 stores the received setting information in the setting-information storage unit 253 (Step S107).

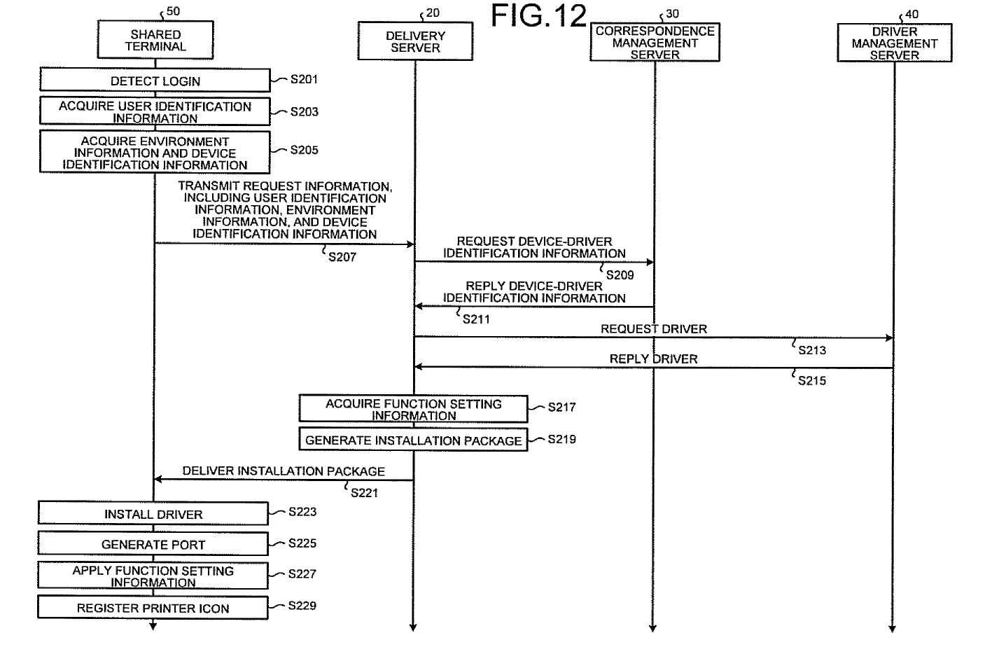

FIG. 12 is a sequence diagram that illustrates an example of an operation to deliver the installation package, executed by the information processing system 1 according to the first embodiment.

First, the detecting unit 551 detects that the user logs in the shared terminal 50 (Step S201).

Then, in accordance with the detection of the user's login by the detecting unit 551, the request-information transmitting unit 553 acquires the user identification information on the user (Step S203).

Then, the request-information transmitting unit 553 acquires the device identification information on the device 51 and the environment information on the shared terminal 50 (Step S205).

Next, the request-information transmitting unit 553 transmits the request information, including the user identification information, the device identification information, and the environment information, which have been acquired, to the delivery server 20, and the request-information receiving unit 255 receives the request information from the shared terminal 50 (Step S207).

Then, the application-information generating unit 257 transmits, to the correspondence management server 30, the device identification information on the device 51 and the environment information on the shared terminal 50, included in the request information that is received by the request-information receiving unit 255, thereby requesting the device-driver identification information on the printer driver to control the device 51 in the environment of the shared terminal 50 (Step S209).

Then, when the correspondence-information communication unit 353 receives the device identification information on the device 51 and the environment information on the shared terminal 50 from the delivery server 20, the correspondence-information communication unit 353 acquires, from the correspondence-information storage unit 351, the device-driver identification information that is related to the device identification information and the environment information, and replies the device-driver identification information to the delivery server 20 (Step S211).

Then, when the application-information generating unit 257 receives the device-driver identification information from the correspondence management server 30, the application-information generating unit 257 transmits the device-driver identification information to the driver management server 40, thereby requesting the printer driver to control the device 51 in the environment of the shared terminal 50 (Step S213).

Then, when the driver communication unit 453 receives the device-driver identification information from the delivery server 20, the driver communication unit 453 acquires the printer driver that is related to the device-driver identification information from the driver storage unit 451 and replies the printer driver to the delivery server 20 (Step S215).

Then, when the application-information generating unit 257 receives, from the driver management server 40, the printer driver to control the device 51 in the environment of the shared terminal 50, the application-information generating unit 257 acquires, from the setting-information storage unit 253, the function setting information, included in the setting information that includes the user identification information, included in the request information that is received by the request-information receiving unit 255 (Step S217).

Next, the application-information generating unit 257 installs the acquired printer driver in the shared terminal 50 and generates an installation package for applying the function setting, indicated by the acquired function setting information, to the installed printer driver (Step S219).

Then, the delivering unit 259 delivers the installation package, generated by the application-information generating unit 257, to the shared terminal 50, and the application-information receiving unit 555 receives the installation package from the delivery server 20 and executes the received installation package (Step S221).

Next, the applying unit 557 installs the printer driver for controlling the device 51, included in the installation package, in the shared terminal 50 (Step S223) and generates a port for the printer driver (Step S225).

Then, the applying unit 557 applies the printing setting, indicated by the function setting information, which is used to generate the installation package, to the installed printer driver as the printing setting for the device 51 (Step S227) and registers the printer icon that indicates the device 51 and that manages the printing setting for the device 51 (Step S229).

As described above, according to the first embodiment, when the user uses the device 51 with the shared terminal 50, the user may use the printing setting in the same manner as in the case where the device 11 is used with the user terminal 10 without manually changing the printing setting.

In this way, according to the first embodiment, the function setting may be applied on a per user basis; therefore, even for a terminal of which the user is changed in an uncertain manner, e.g., it is used by a large number of users, the function setting may be applied appropriately for the use mode of each user. Furthermore, as in the conventional technologies, if the printing setting can be made only on a per printer-driver basis, the same printing setting is applied to every user; therefore, it is difficult to apply the function setting appropriately for the use mode of each user as in the first embodiment.

### Modified Example 1

In the above-described first embodiment, an explanation is given of a case where, for example, the printer driver is also installed by using the installation package; however, the printer driver may be previously installed in the shared terminal 50. In this case, the installation package may be a package for applying the printing setting, indicated by the function setting information, which is used to generate the installation package, to the printing setting of the printer driver for the device 51, installed in the shared terminal 50.

That is, according to the modified example 1, the request information does not need to include the device identification information for identifying the device 51 or the environment information that indicates the environment of the shared terminal 50, and the application-information generating unit 257 does not need to request the device-driver identification information on the printer driver for controlling the device 51 in the environment of the shared terminal 50 from the correspondence management server 30, or does not need to request the printer driver for controlling the device 51 in the environment of the shared terminal 50 from the driver management server 40. Furthermore, when the detecting unit 551 detects that the user logs off the shared terminal 50, the applying unit 557 does not need to uninstall the printer driver, which is installed in the shared terminal 50, but the applying unit 557 only has to delete the registered printer icon.

### Modified Example 2

In the above-described first embodiment, an explanation is given of a case where, for example, the application-information generating unit 257 acquires the printer driver for controlling the device 51 in the environment of the shared terminal 50 from the driver management server 40; however, if the printer driver has been already acquired from the driver management server 40, the acquired printer driver may be used.

Specifically, when the application-information generating unit 257 acquires the device-driver identification information from the correspondence management server 30, the application-information generating unit 257 checks whether the printer driver, indicated by the device-driver identification information, has been acquired and, if the printer driver has not been acquired, the printer driver may be acquired from the driver management server 40.

### Modified Example 3

According to the above-described first embodiment, if there are devices that are connected to the shared terminal 50 other than the device 51, the user, who uses the shared terminal 50, may use the input device 509 to select the device to be used on the device selection screen, and the request-information transmitting unit 553 may acquire the device identification information on the selected device.

### Modified Example 4

According to the above-described first embodiment, no problems occur if the printer driver, installed in the user terminal 10, and the printer driver, installed in the shared terminal 50, are compatible with each other or if they are general-use drivers; however, if they are not compatible with each other, there is a possibility that the printing setting in a case where the device 11 is used with the user terminal 10 is not applicable to the printing setting in a case where the device 51 is used with the shared terminal 50.

Therefore, the printer driver, installed in the shared terminal 50, may be a printer driver that is compatible with the printer driver that is installed in the user terminal 10.

For example, the user terminal 10 may include the model name of the printer driver, installed in the user terminal 10, in the setting information, which is transmitted to the delivery server 20, and register the setting information in the delivery server 20, and the application-information generating unit 257 may acquire, from the driver management server 40, the printer driver that controls the device 51 in the environment of the shared terminal 50 and that is compatible with the printer driver of the model name.

Furthermore, for example, if there are devices that are connected to the shared terminal 50 other than the device 51, the user, who uses the shared terminal 50, may use the input device 509 to select the device that is controlled by the printer driver that is compatible with the printer driver, installed in the user terminal 10, and the request-information transmitting unit 553 may acquire the device identification information on the device.

### Modified Example 5

In the above-described first embodiment, an explanation is given of a case where, for example, the information processing system 1 is a local system (a system that is not public); however, it may be implemented as a Web system. In this case, too, if generally needed operations, such as advance user registration, are performed to implement the Web system, implementation may be achieved in the same manner as in the above-described first embodiment.

Here, in the case of the Web system, the setting management program, installed in the user terminal 10, and the installation package request/execution program, installed in the shared terminal 50, are replaced with plug-ins, or the like, operated in the Web browser.

Furthermore, in the case of the Web system, the trigger for transmitting the request information to the delivery server 20 may be a user's operation instead of detection of login in terms of security.

### Second Embodiment

In the second embodiment, an explanation is given of a case where the function setting is applied on a per device basis. Hereafter, the differences from the first embodiment are principally explained, the same name and reference numeral as those in the first embodiment are applied to the components that have the same functions as those in the first embodiment, and the explanations are omitted.

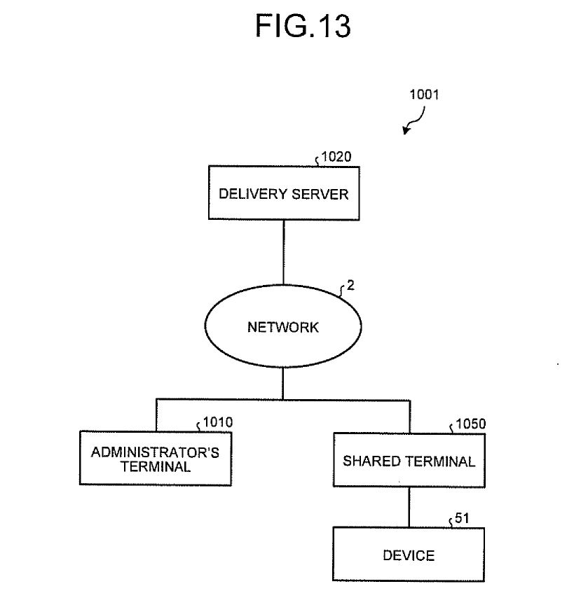

FIG. 13 is a block diagram that illustrates an example of the configuration of an information processing system 1001 according to the second embodiment. As illustrated in FIG. 13, the information processing system 1001 includes an administrator's terminal 1010, a delivery server 1020, a shared terminal 1050, and the device 51.

Furthermore, the administrator's terminal 1010 is an example of the first information processing apparatus, the shared terminal 1050 is an example of the second information processing apparatus, and the delivery server 1020 is an example of a third information processing apparatus.

The administrator's terminal 1010 is a terminal device that is used by the administrator, and includes, for example, a PC or a smart device. The administrator's terminal 1010 determines the printing setting of the shared terminal 1050 with regard to the device 51.

Contrary to the first embodiment, the shared terminal 1050 has the printer driver for controlling the device 51 installed therein. Furthermore, the connection topology between the shared terminal 1050 and the device 51 is a local connection using a communication cable.

Furthermore, according to the second embodiment, an explanation is given of a case where, for example, the administrator's terminal 1010, the shared terminal 1050, and the device 51 are located in the main office; however, this is not a limitation.

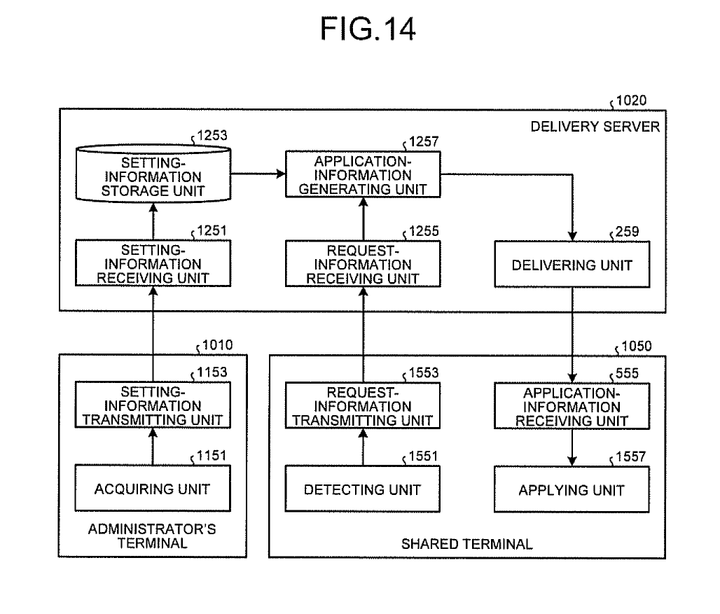

FIG. 14 is a block diagram that illustrates an example of the functional configuration of the information processing system 1001 according to the second embodiment. As illustrated in FIG. 14, it is different from the first embodiment in an acquiring unit 1151 and a setting-information transmitting unit 1153 of the administrator's terminal 1010, a setting-information receiving unit 1251, a setting-information storage unit 1253, an application-information generating unit 1257, and a request-information receiving unit 1255 of the delivery server 1020, and a detecting unit 1551, a request-information transmitting unit 1553, and an applying unit 1557 of the shared terminal 1050.

The acquiring unit 1151 acquires the function setting information that indicates the printing setting of the printer driver for the device 51, installed in the shared terminal 1050, and the device identification information for identifying the device 51.

The technique for acquiring the function setting information may be the same as that in the first embodiment. In this case, the same printer driver as that installed in the shared terminal 1050 needs to be installed in the administrator's terminal 1010, and the device of the same model as that of the device 51 needs to be connected to the administrator's terminal 1010. Furthermore, it is possible that the same printer driver as that installed in the shared terminal 1050 is installed in the administrator's terminal 1010, the administrator makes the printing setting on the property screen of the printer driver so as to store the function setting information that indicates the printing setting, and the acquiring unit 1151 acquires the function setting information.

The device identification information includes, for example, the model name of the device. If the device of the same model as that of the device 51 is connected to the administrator's terminal 1010, the acquiring unit 1151 performs the SNMP communication with the device so as to acquire the same device identification information as that of the device 51. Furthermore, for example, the acquiring unit 1151 may acquire the device identification information on the device 51, input by the administrator.

The setting-information transmitting unit 1153 transmits, to the delivery server 1020, the setting information that includes the function setting information and the device identification information, acquired by the acquiring unit 1151.

The setting-information receiving unit 1251 receives the setting information from the administrator's terminal 1010 and stores the setting information in the setting-information storage unit 1253.

The detecting unit 1551 detects a connection with the device 51. The connection detection function of the detecting unit 1551 may be implemented by using, for example, a function (e.g., a plug and play function) of the operating system (OS), installed in the shared terminal 1050.

The request-information transmitting unit 1553 transmits the request information, including the device identification information on the device 51, to the delivery server 1020. According to the second embodiment, the request-information transmitting unit 1553 transmits the request information to the delivery server 1020 in accordance with detection of the connection with the device 51 by the detecting unit 1551. The technique for acquiring the device identification information is the same as that in the first embodiment. Furthermore, protocols other than SNMP may be used.

The request-information receiving unit 1255 receives the request information from the shared terminal 1050.

The application-information generating unit 1257 acquires, from the setting-information storage unit 1253, the function setting information, included in the setting information that includes the device identification information, which is included in the request information that is received by the request-information receiving unit 1255, and generates the installation package for applying the function setting that is indicated by the function setting information.

Then, the application-information generating unit 1257 generates an installation package for applying the function setting, indicated by the acquired function setting information, to the printer driver that is installed in the shared terminal 1050. Here, the installation package may be generated by using a well-known technology.

The delivering unit 259 and the application-information receiving unit 555 are the same as those in the first embodiment.

On the basis of the installation package that is received by the application-information receiving unit 555, the applying unit 1557 applies the printing setting, indicated by the function setting information, which is used to generate the installation package, to the printing setting of the printer driver for the device 51, installed in the shared terminal 1050.

For example, when the application-information receiving unit 555 executes the received installation package so that the installer of the installation package is installed in the shared terminal 1050, the applying unit 1557 notifies the installed printer driver of the printing setting, indicated by the function setting information, which is used to generate the installation package, and gives a command to register the printing setting. Thus, the printer driver, installed in the shared terminal 1050, applies the notified printing setting to the printing setting for the device 51 and registers the printer icon that indicates the device 51 and that manages the printing setting for the device 51.

Thus, if the device 51 is used with the shared terminal 1050, it is possible to use the printing setting that is determined by the administrator.

Then, when the detecting unit 1551 detects disconnection between the shared terminal 1050 and the device 51, the applying unit 1557 deletes the printer icon that is registered in the shared terminal 1050.

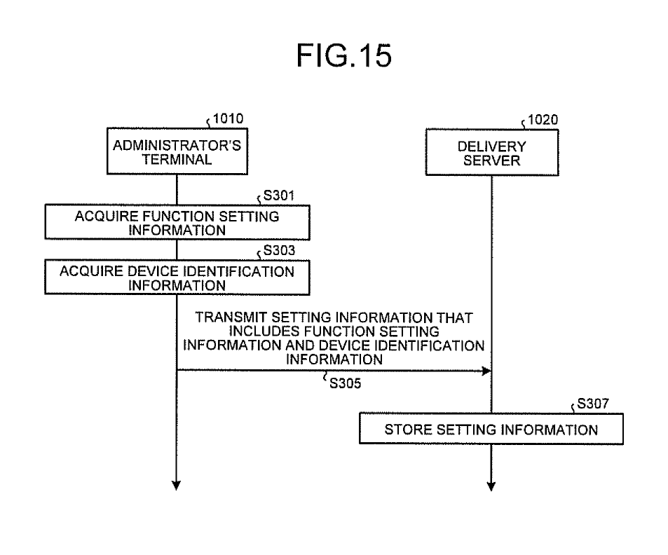

FIG. 15 is a sequence diagram that illustrates an example of an operation to store the setting information, performed by the information processing system 1001 according to the second embodiment.

First, the acquiring unit 1151 acquires the function setting information that indicates the printing setting of the printer driver with regard to the device 51, installed in the shared terminal 1050 (Step S301).

Next, the acquiring unit 1151 acquires the device identification information on the device 51 (Step S303).

Then, the setting-information transmitting unit 1153 transmits the setting information that includes the function setting information and the device identification information, acquired by the acquiring unit 1151, to the delivery server 1020, and the setting-information receiving unit 1251 receives the setting information from the administrator's terminal 1010 (Step S305).

Then, the setting-information receiving unit 1251 stores the received setting information in the setting-information storage unit 1253 (Step S307).

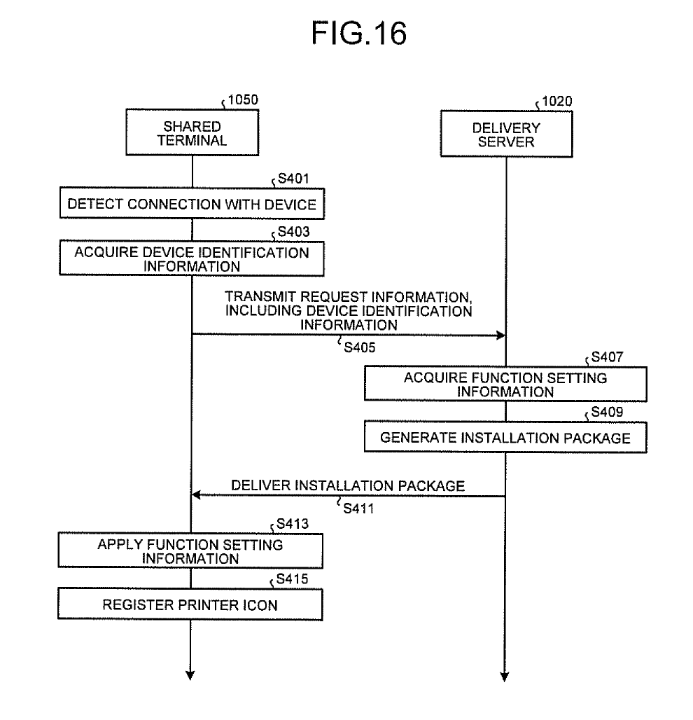

FIG. 16 is a sequence diagram that illustrates an example of an operation to deliver an installation package, performed by the information processing system 1001 according to the second embodiment.

First, the detecting unit 1551 detects the connection with the device 51 (Step S401).

Next, the request-information transmitting unit 1553 acquires the device identification information on the device 51 (Step S403).

Then, the request-information transmitting unit 1553 transmits the request information, including the device identification information on the device 51, to the delivery server 1020, and the request-information receiving unit 1255 receives the request information from the shared terminal 1050 (Step S405).

Then, the application-information generating unit 1257 acquires, from the setting-information storage unit 1253, the function setting information, included in the setting information that includes the device identification information, included in the request information that is received by the request-information receiving unit 1255 (Step S407).

Next, the application-information generating unit 1257 generates the installation package for applying the function setting, indicated by the acquired function setting information, to the printer driver, installed in the shared terminal 1050 (Step S409).

Then, the delivering unit 259 delivers the installation package, generated by the application-information generating unit 1257, to the shared terminal 1050, and the application-information receiving unit 555 receives the installation package from the delivery server 1020 and executes the received installation package (Step S411).

Then, the applying unit 1557 applies the printing setting, indicated by the function setting information, which is used to generate the installation package, to the installed printer driver as the printing setting for the device 51 (Step S413) and registers the printer icon that indicates the device 51 and that manages the printing setting for the device 51 (Step S415).

As described above, according to the second embodiment, if the device 51 is used with the shared terminal 1050, it is possible to use the printing setting that is determined by the administrator.

In this way, according to the second embodiment, as the function setting may be applied on a per device basis, different printing settings may be applied to multiple devices, of which the printer drivers as the control targets are the same, e.g., multiple devices of the same model; therefore, even in a case where devices of the same model are installed in multiple sections, a different printing setting may be applied to the terminal, using the device, in each section. Furthermore, as in the conventional technologies, if the printing setting may be made only on a per printer-driver basis, the same printing setting is applied to every device; therefore, it is difficult to apply the function setting appropriately for the use mode of each device as in the second embodiment.

### Modified Example 6

In the above-described second embodiment, too, an explanation is given of a case where, for example, the information processing system 1001 is a local system (the system that is not public); however, it may be implemented as a Web system. In this case, too, if generally needed operations, such as advance user registration, are performed to implement the Web system, implementation may be achieved in the same manner as in the above-described first embodiment.

Furthermore, in the case of the Web system, the setting management program, installed in the administrator's terminal 1010, and the installation package request/execution program, installed in the shared terminal 1050, are replaced with plug-ins, or the like, operated in the Web browser.

### Modified Example 7

In the above-described second embodiment, an explanation is given of a case where, for example, the terminal that uses the device 51 is the shared terminal that is used by a large number of users; however, this is not a limitation, and it may be a user terminal that is used exclusively by a user.

### Modified Example 8

In the above-described first and second embodiments, an explanation is given of a case where, for example, the device driver is a printer driver; however, this is not a limitation and, for example, it may be a driver that is capable of controlling the device, such as the facsimile driver that controls the facsimile machine, or the scanner driver that controls the scanner device.

According to the embodiments of the present invention, there are advantages such that the function setting may be applied appropriately for the use mode.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
a first information processing apparatus;
a second information processing apparatus; and
a delivery system, wherein
the first information processing apparatus includes a processor, in communication with a memory, executes steps of:
acquiring function setting information that indicates a function setting of a first device driver applied to the first information processing apparatus to control a first device that is used with the first information processing apparatus and user identification information for identifying a user who uses the first information processing apparatus; and
transmitting setting information including the function setting information and the user identification information to the delivery system,
the delivery system includes a processor, in communication with a memory, executes steps of:
receiving the setting information from the first information processing apparatus and stores the setting information;
receiving request information including the user identification information on the user from the second information processing apparatus;
acquiring function setting information included in setting information that includes the user identification information included in the request information and generating application information for applying a function setting indicated by the function setting information; and
delivering the application information to the second information processing apparatus, and
the second information processing apparatus includes a processor, in communication with a memory, executes steps of:
transmitting the request information to the delivery system;
receiving the application information from the delivery system; and
applying the application information to apply a function setting indicated by the function setting information to a function setting of a second device driver applied to the second information processing apparatus to control a second device that is used with the second information processing apparatus with regard to the second device.

2. The information processing system according to claim 1, wherein
the request information further includes device identification information for identifying the second device,
the processor in the delivery system, based on correspondence information which relates device identification information on a device to device-driver identification information for identifying a device driver to control the device, further executes steps of acquiring the second device driver indicated by device-driver identification information that corresponds to device identification information on the second device, and generating, as the application information, information for applying the second device driver and for applying a function setting, indicated by the function setting information, to the second device driver, and
applying the application information to apply the second device driver to the second information processing apparatus and apply a function setting indicated by the function setting information to a function setting of the second device driver with regard to the second device.

3. The information processing system according to claim 2, wherein
the request information further includes environment information that indicates an environment of the second information processing apparatus,
the correspondence information is information that relates the device identification information, the environment information on an information processing apparatus, and device-driver identification information for identifying a device driver to control the device in the environment, indicated by the environment information, and
the processor in the delivery system further executes the steps of acquiring the second device driver indicated by device-driver identification information corresponding to the device identification information on the second device and the environment information on the second information processing apparatus.

4. The information processing system according to claim 1, wherein the processor in the first information processing apparatus executes steps of acquiring the function setting information by extracting the function setting from the first device driver.

5. The information processing system according to claim 1, wherein the processor in the first information processing apparatus executes steps of acquiring the function setting information that is previously generated by the first device driver.

6. The information processing system according to claim 1, wherein
the processor in the second information processing apparatus further executes steps of detecting that a user has authority to use the second information processing apparatus in accordance with an input of the user identification information from the user, and
transmitting the request information to the delivery system in accordance with detection of the authority of use.

7. An information processing apparatus comprising a processor, in communication with a memory, executes steps of:
receiving from a first information processing apparatus setting information including function setting information that indicates a function setting of a first device driver applied to the first information processing apparatus to control a first device that is used with the first information processing apparatus with regard to the first device and user identification information for identifying a user who uses the first information processing apparatus;
receiving request information including the user identification information on the user from a second information processing apparatus;
aquiring function setting information included in setting information that includes the user identification information included in the request information and generating application information for applying a function setting indicated by the function setting information to a function setting of a second device driver applied to the second information processing apparatus to control a second device that is used with the second information processing apparatus; and
delivering the application information to the second information processing apparatus.

8. An application method that is implemented by an information processing system that includes a first information processing apparatus, a second information processing apparatus, and a delivery system, the application method comprising steps of:
acquiring function setting information that indicates a function setting of a first device driver applied to the first information processing apparatus to control a first device that is used with the first information processing apparatus with regard to the first device and user identification information for identifying a user who uses the first information processing apparatus; and
transmitting setting information including the function setting information and the user identification information to the delivery system,
receiving the setting information from the first information processing apparatus;
receiving request information including the user identification information on the user from the second information processing apparatus;
acquiring function setting information included in setting information that includes the user identification information included in the request information and generating application information for applying a function setting indicated by the function setting information; and
delivering the application information to the second information processing apparatus, and
transmitting the request information to the delivery system;
receiving the application information from the delivery system; and
applying the application information to apply a function setting indicated by the function setting information to a function setting of a second device driver applied to the second information processing apparatus to control a second device that is used with the second information processing apparatus with regard to the second device.
